(19) United States
(12) Patent Application Publication
(10) Pub. No.: US 2018/0161685 A1
(43) Pub. Date: Jun. 14, 2018

(54) EMOTIONAL SUPPORT TOY SYSTEM AND METHOD

(71) Applicants: Cecil Garren, Dearborn, MI (US); Andrew Skinner, Dearborn, MI (US)

(72) Inventors: Cecil Garren, Dearborn, MI (US); Andrew Skinner, Dearborn, MI (US)

(21) Appl. No.: 15/725,885

(22) Filed: Oct. 5, 2017

Related U.S. Application Data
(60) Provisional application No. 62/397,355, filed on Sep. 21, 2016.

(51) Int. Cl. A63H 3/00; G09B 19/00; A63H 3/02; A63H 3/16; A63H 3/52; A45F 3/14

(52) U.S. Cl. CPC A63H 3/005; G09B 19/00; A63H 3/02; A45F 2003/146; A63H 3/52; A45F 3/14; A63H 3/16

(57) ABSTRACT

A toy includes a body, a garment, a plurality of shapes, at least one pocket, and a plurality of attachment points. The body may include a head and a set of limbs, a garment configured to cover the body, a plurality of shapes removably attached to the garment, at least one pocket attached to the body, and configured to store the plurality of shapes. A plurality of attachment points may be coupled to the body, and configured to allow attachment of the doll to another object. The toy may be configured in a manner resembling a motherly figure for entertainment and to provide emotional support to a child that may be struggling with grieving.

### CROSS-REFERENCE TO RELATED APPLICATION(S)

The present application is related to and claims priority to U.S. Provisional Patent Application No. 62/397,355 filed Sep. 21, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of children's toys of existing art and more specifically relates to dolls as emotional support toys and use thereof.

### RELATED ART

Many children play with stuffed toys. A stuffed toy is a toy sewn from a textile, and stuffed with a soft material. Textiles commonly used include plain cloth and pile textiles like plush or terrycloth. Common stuffing materials are synthetic fiber batting, cotton, straw, wood, wool, plastic pellets or beans. They are often used as a source of entertainment, for display or collecting, or given as gifts.

U.S. Pub. No. 2007/0207698 to Cathleen Stanley relates to a toy to aid emotional transitions. The described toy includes a personalized transitional item or toy, that can be a stuffed animal, to aid in the emotional transitions of children that are about to undergo a significant loss. It is a stuffed toy that has the capacity to store memorabilia in its interior. The toy itself will be plush and huggable and can be called the Healing Hearts Bear and function as both a practical toy and a holder for meaningful possessions. The cavity will be used to contain items of emotional significance to the child and will be selected and placed in the cavity by an adult or counselor and returned to the child. The toy can be used to aid children undergoing an emotional transition such as death or loss of a loved one, personal injury or illness.

### SUMMARY OF THE INVENTION

In view of the foregoing disadvantages inherent in the known children's toys art, the present disclosure provides a novel emotional support toy. The general purpose of the present disclosure, which will be described subsequently in greater detail, is to provide an emotional support doll for effective use.

A toy is disclosed herein. The toy includes a body, a garment, a plurality of shapes, at least one pocket, and a plurality of attachment points. The body may include a head and a set of limbs, a garment configured to cover the body, a plurality of shapes removably attached to the garment, at least one pocket attached to the body, and as such is configured to store the plurality of shapes. A plurality of attachment points may be coupled to the body, and configured to allow attachment of the doll to another object.

A plurality of shapes may include hearts or keepsakes such as pictures, buttons, pins, scraps of clothing, and the like. Some shapes may be permanently sewn to the garment of the toy while other shapes may be affixed/fixed in a fashion so that they are removable. Keepsakes may also be placed in an internal cavity so that they may be easily retrievable for viewing. The internal cavity may be closed with a zipper (zipping fastener) for securing the keepsakes within the toy. A child often collects items given to them by adults that are close to the child. The toy may provide a special holder for these keepsakes.

The toy may include attachment points for attaching to another object, and alternately, to affix straps for the purpose of wearing the toy similar to a backpack. The toy measures approximately twelve inches in length. When wearing the toy as a backpack, the attachment points may be designed for a traditional two strap backpack harness or may be of a messenger bag single-strap style. The toy may be configured in a manner resembling a motherly figure for entertainment and to provide emotional support to a child that may be struggling with grieving.

According to another embodiment, a method of using the toy is also disclosed herein. The method of using a toy includes opening an internal cavity located in the toy, removing a plurality of shapes from the internal cavity, placing the plurality of shapes on a garment of the toy, placing a keepsake into the internal cavity, closing the internal cavity, removing a plurality of shapes from a garment of a toy, and storing the plurality of shapes in an internal cavity.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an emotional support toy, constructed and operative according to the teachings of the present disclosure.

FIG. 1 is a perspective view of the (emotional support) toy during an ‘in-use’ condition, according to an embodiment of the disclosure.

FIG. 2 is a perspective view of the toy of FIG. 1, according to an embodiment of the present disclosure.

FIG. 3 is a front view of the toy of FIG. 1, according to an embodiment of the present disclosure.

FIG. 4 is a rear view of the toy of FIG. 1, according to an embodiment of the present disclosure.

FIG. 5 is a flow diagram illustrating a method of using a toy, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an emotional support toy for children and more particularly to a doll as used to improve the emotional state of a child after experiencing a loss or emotional hardship.

Generally, ‘Esmerelda’ is a toy doll that is soft plush. The doll is preferably twelve inches high, and eleven inches hand to hand. The doll preferably has a purple dress that is decorated all over with hearts or other shapes. The doll can represent the child's mother or any other female adult figure that a child derives comfort from. Seeing the doll can calm the child so that he or she is no longer afraid. The doll has a zipper (zipping or other fastening means) in the back where the child can store keepsakes given to him or her by a female adult figure, as well as extra hearts or other shapes for the doll. Use of the present invention provides soothing relief.

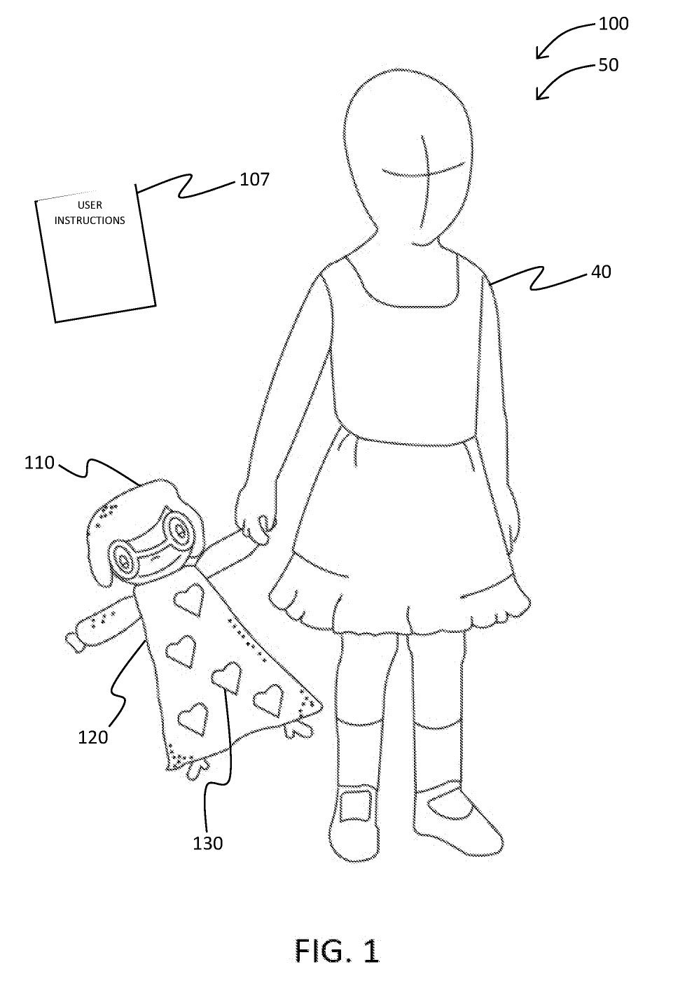

Referring now more specifically to the drawings by numerals of reference, there is shown in FIGS. 1-4, various views of a toy 100.

FIG. 1 shows a toy 100 during an ‘in-use’ condition 50, according to an embodiment of the present disclosure. Here, the toy 100 may be beneficial for use by a user 40 to sooth an emotional state of a child after experiencing a loss or emotional hardship. As illustrated, the toy 100 may include a body 110, a garment 120, a plurality of shapes 130, at least one pocket 140, and a plurality of attachment points 150. The body 110 may have a set of limbs 112, a garment 120 configured to cover the body 110; a plurality of shapes 130 being removably attached to the garment 120, at least one pocket 140 attached to the body 110 and configured to store the plurality of shapes 130, and a plurality of attachment points 150 coupled to the body 110, and configured to allow attachment of the doll to another object. The toy 100 may be configured to be representative of a motherly figure, and may further entertain and provide emotional support to a child.

The plurality of shapes 130 may be hearts, symmetrical shapes, and asymmetrical shapes. The plurality of shapes 130 may be housed in an internal cavity 114. The internal cavity 114 may include a zipper style fastener 116 attached to the internal cavity 114 and configured to conceal the internal cavity 114 when closed. The zipper style fastener 116 is positioned at a predetermined distance below an armpit of the doll, between four inches to six inches.

According to one embodiment, the toy 100 may be arranged as a kit 105. In particular, the toy 100 may further include a set of instructions 107. The instructions 107 may detail functional relationships in relation to the structure of the toy 100 such that the toy 100 can be used, maintained, or the like, in a preferred manner.

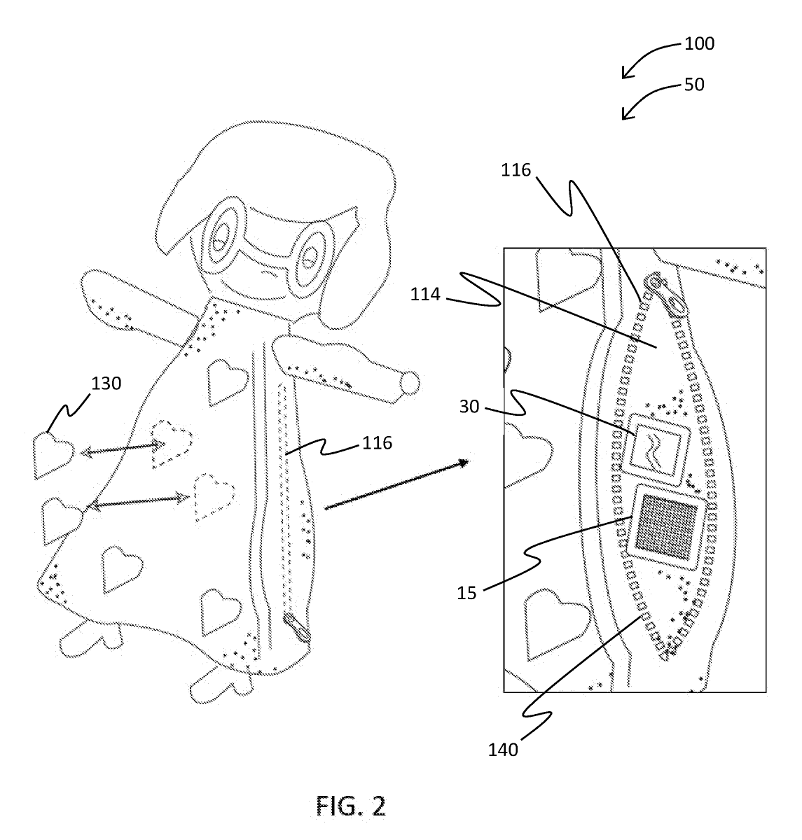

FIG. 2 shows the toy 100 of FIG. 1, according to an embodiment of the present disclosure. As above, the toy 100 may include a body 110, a garment 120, a plurality of shapes 130, at least one pocket 140, and a plurality of attachment points 150. The body 110 may include a set of limbs 112, a garment 120 configured to cover the body 110, a plurality of shapes 130 being removably attached to the garment 120, at least one pocket 140 attached to the body 110 and configured to store the plurality of shapes 130, and a plurality of attachment points 150 coupled to the body 110. The present invention is configured to allow attachment of the doll 100 to another object.

The plurality of shapes 130 may include hearts, symmetrical shapes, and asymmetrical shapes. The internal cavity 114 may be configured to store objects larger than the plurality of shapes 130, and the plurality of shapes 130 may be removably attached by an adhesive, and alternately a hook and loop fastener. Larger objects than the plurality of shapes 130 may be selected from any combination of items such as a keepsake 15, a token 20, a memento 25, and a picture 30.

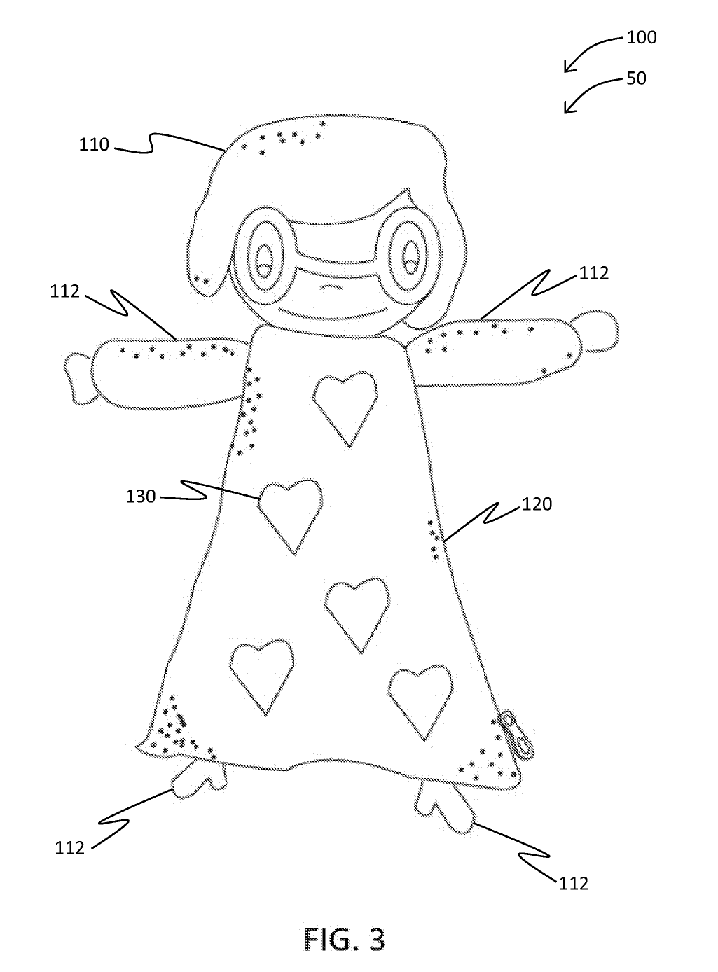

FIG. 3 is a front view of the toy 100 of FIG. 1, according to an embodiment of the present disclosure. The garment 120 may comprise a triangular-shaped dress. A plurality of hearts may be used as decoration on the garment 120 of the toy 100.

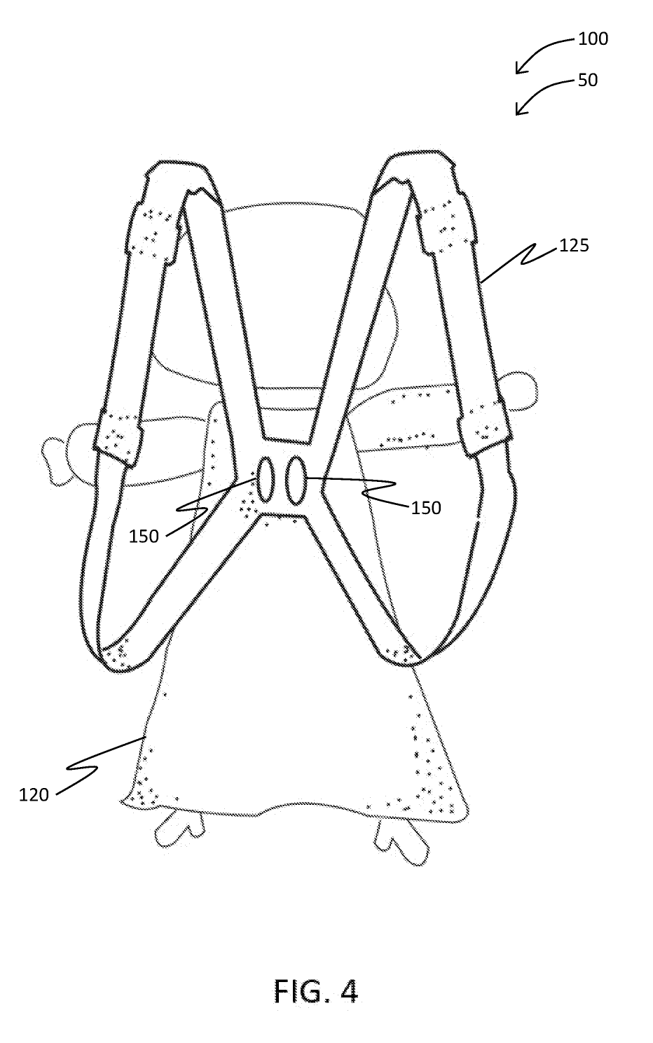

FIG. 4 is a rear view of the toy of FIG. 1, according to an embodiment of the present disclosure. The toy 100 may have a plurality of attachment points 150, permitting the child to attach the doll 100 to another object. Further, the plurality of attachment points 150 may be configured to attach the toy 100 to a backpack harness 125 or the like.

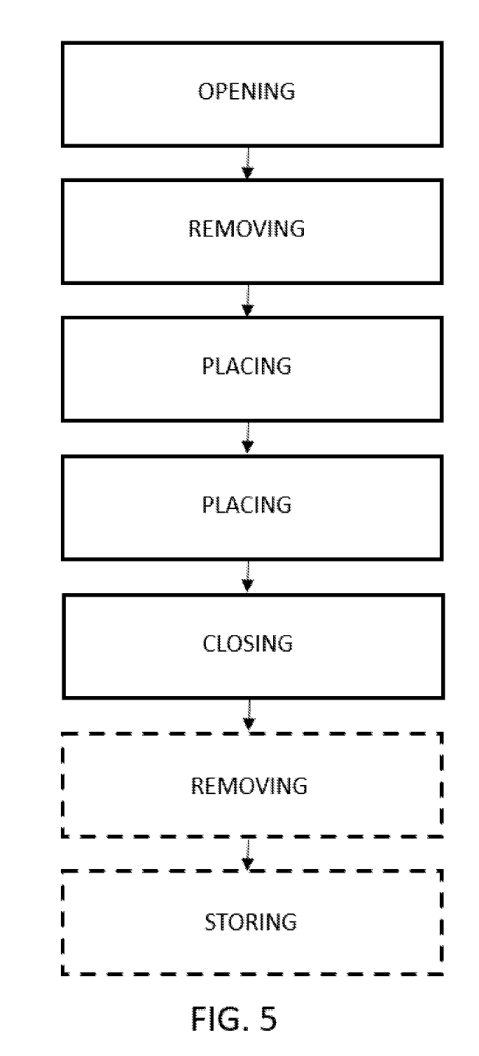

FIG. 5 is a flow diagram illustrating a method for using 500 a toy 100, according to an embodiment of the present disclosure. In particular, the method for using 500 a toy 100 may include one or more components or features of the toy 100 as described above. As illustrated, the method for using 500 a toy 100 may include the steps of: step one 501, opening an internal cavity 114 located on a toy 100; step two 502, removing a plurality of shapes 130 from the internal cavity 114; step three 503, placing the plurality of shapes 130 on a garment 120 of the toy 100; step four 504, placing a keepsake into the internal cavity 114; step five 505, closing the internal cavity 114; step six 506, removing a plurality of shapes 130 from a garment 120 of a toy 100, and step seven 507, storing the plurality of shapes 130 in an internal cavity 114.

It should be noted that steps 506, and 507 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using a toy 100, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A toy, the toy comprising:
a body, the body having a head and a set of limbs;
a garment, the garment configured to cover the body;
a plurality of shapes, the plurality of shapes being removably attached to the garment;
at least one pocket, the at least one pocket attached to the body and configured to store the plurality of shapes;
a plurality of attachment points, the plurality of attachment points coupled to the body, and configured to allow attachment of the doll to another object; and
wherein the toy is configured to entertain and provide emotional support to a child.

2. The toy of claim 1, wherein the plurality of shapes are hearts.

3. The toy of claim 2, wherein the plurality of shapes is symmetrical.

4. The toy of claim 2, wherein the plurality of shapes is asymmetrical.

5. The toy of claim 1, wherein the toy is configured to be representative of a motherly figure.

6. The toy of claim 1, wherein the body has an internal cavity.

7. The toy of claim 4, further including a zipper style fastener, the zipper style fastener being attached to the internal cavity and configured to conceal the internal cavity.

8. The toy of claim 5, wherein the zipper style fastener is positioned at a predetermined distance below an armpit of the doll.

9. The toy of claim 6, wherein the predetermined distance is a length of 4 inches to 6 inches.

10. The toy of claim 7, wherein the internal cavity is configured to store objects larger than the plurality of shapes.

11. The toy of claim 1, wherein each of the plurality of shapes is removably attached by an adhesive.

12. The toy of claim 1, wherein each of the plurality of shapes is removably attached by a hook and loop fastener.

13. The toy of claim 1, wherein the pocket is sewn on a back of the doll.

14. The toy of claim 1, wherein the plurality of attachment points is configured to attach the toy to a backpack harness.

15. The toy of claim 8, wherein the objects larger than the plurality of shapes are selected from the group comprising of a keepsake, a token, a memento, and a picture.

16. The toy of claim 1, wherein the garment comprises a triangular-shaped dress.

17. A toy comprising:
a body, the body having a head and a set of limbs;
a garment, the garment configured to cover the body;
wherein the garment comprises a triangular-shaped dress;
wherein the body has an internal cavity further including a zipper style fastener, the zipper style fastener being attached to the internal cavity and configured to conceal the internal cavity;
wherein the internal cavity is configured to store objects larger than the plurality of shapes;
wherein the zipper style fastener is positioned at a predetermined distance below an armpit of the doll;
wherein the predetermined distance is a length of 4 inches to 6 inches;
a plurality of shapes, the plurality of shapes being removably attached to the garment;
wherein each of the plurality of shapes is removably attached by a hook and loop fastener;
wherein the plurality of shapes are hearts, the plurality of shapes is symmetrical;
at least one pocket, the at least one pocket attached to the body and configured to store the plurality of shapes;
a plurality of attachment points, the plurality of attachment points coupled to the body, and configured to allow attachment of the doll to another object;
wherein the plurality of attachment points is configured to attach the toy to a backpack harness;
wherein the toy is configured to be representative of a motherly figure; and
wherein the toy is configured to entertain and provide emotional support to a child.

18. The toy of claim 17, further comprising set of instructions; and
wherein the toy is arranged as a kit.

19. A method of using a toy, the method comprising the steps of:
opening an internal cavity located on the toy;
removing a plurality of shapes from the internal cavity;
placing the plurality of shapes on a garment of the toy;
placing a keepsake into the internal cavity; and
closing the internal cavity.

20. The method of claim 19, further comprising the steps of:
removing the plurality of shapes from the garment of the toy; and
storing the plurality of shapes in the internal cavity.
